(19) United States
(12) Patent Application Publication
(10) Pub. No.: US 2010/0118941 A1
(43) Pub. Date: May 13, 2010

(54) FRAME ACCURATE SWITCHING

(75) Inventors: Ray Taylor, Hampshire (GB); Ian R. Shelton, Hampshire (GB); Kevin A. Murray, Hampshire (GB); James Geoffrey Walker, Hampshire (GB)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: NDS Limited, Staines, Middlesex (GB)

(21) Appl. No.: 12/451,578

(22) PCT Filed: Apr. 28, 2008
(86) PCT No.: PCT/IB2008/051639

§ 371 Date: Dec. 29, 2009

(51) Int. Cl. H04N 7/12

(52) U.S. Cl. 375/240.12; 375/240.25; 375/E07.243

(57) ABSTRACT

A system comprising a decoder arrangement to decode a plurality of video sequences including a first video sequence and a second video sequence, each of the video sequences including a plurality of frames including a first plurality of reference frames and a second plurality of non-reference frames, a selector operationally connected to the decoder arrangement, the selector being operative to select which of the video sequences is outputted to a display device for display, wherein during at least some of the time while the decoder arrangement is decoding the second video sequence which is selected for output to the display device, the decoder arrangement is operative to selectively decode the first video sequence, and then the selector is operative to switch to selecting the first video sequence for outputting to the display device for display. Related apparatus and methods are also described.

### FIELD OF THE INVENTION

The present invention relates to frame accurate switching.

### BACKGROUND OF THE INVENTION

The following references are also believed to represent the state of the art:

US Published Patent Application 2002/0097801 of Martin;

US Published Patent Application 2003/0039471 of Hashimoto;

PCT Published Patent Application WO 98/32284 of NDS Limited;

PCT Published Patent Application WO 2001/52541 of NDS Limited;

PCT Published Patent Application WO 2004/72935 of NDS Limited;

PCT Published Patent Application WO 2005/122688 of NDS Limited;

ISO/IEC International Standard 13818-2, Information Technology—Generic coding of moving pictures and associated audio information: Video; and

ISO/IEC International Standard 14496-10, Information Technology—Coding of audio-visual objects—Part 10: Advanced Video Coding.

### SUMMARY OF THE INVENTION

The present invention seeks to provide improved frame accurate switching.

There is thus provided in accordance with an embodiment of the present invention a system including a decoder arrangement to decode a plurality of video sequences including a first video sequence and a second video sequence, each of the video sequences including a plurality of frames including a first plurality of reference frames and a second plurality of non-reference frames, a selector operationally connected to the decoder arrangement, the selector being operative to select which of the video sequences is outputted to a display device for display, wherein during at least some of the time while the decoder arrangement is decoding the second video sequence which is selected for output to the display device, the decoder arrangement is operative to selectively decode the first video sequence, and then the selector is operative to switch to selecting the first video sequence for outputting to the display device for display.

Further in accordance with an embodiment of the present invention the selective decoding is performed by decoding at least one, but not all, of the frames in the first video sequence, by skipping at least one of the frames of the first video sequence while in the midst of selectively decoding the first video sequence.

Still further in accordance with an embodiment of the present invention the selective decoding maintains a state of the first video sequence such that any subsequent frame in the first video sequence can be decoded whereby full decoding of the first video sequence can be resumed at any point without any noticeable visual artifacts.

Additionally in accordance with an embodiment of the present invention while the decoder arrangement is decoding the second video sequence which is selected for output to the display device, the selective decoding of the first video sequence on average uses less resources of the decoder arrangement than the decoding of the second video sequence which is currently being decoded.

Moreover in accordance with an embodiment of the present invention prior to the decoding of the second video sequence with the selective decoding of the first video sequence the selector is operative to select the first video sequence for decoding by the decoder arrangement and outputting to the display device, and then the selector is operative to select the second video sequence for decoding by the decoder arrangement and outputting to the display device.

Further in accordance with an embodiment of the present invention during the selective decoding of the first video sequence, at least some of the non-reference frames in the midst of the first video sequence being selectively decoded are not decoded.

Still further in accordance with an embodiment of the present invention during the selective decoding of the first video sequence at least a majority of the frames of the first video sequence being decoded are reference frames.

Additionally in accordance with an embodiment of the present invention the reference frames include a plurality of intra coded frames, and during the selective decoding of the first video sequence, at least a majority of the frames of the first video sequence being decoded are intra coded frames.

Moreover in accordance with an embodiment of the present invention while the first video sequence is being decoded and selected for output to the display device, the first video sequence is fully decoded.

Further in accordance with an embodiment of the present invention while the second video sequence is being decoded and selected for output to the display device, the second video sequence is fully decoded.

Still further in accordance with an embodiment of the present invention during a majority of the time while the decoder arrangement is decoding the second video sequence which is selected for output to the display device, the decoder arrangement is operative to selectively decode the first video sequence.

Additionally in accordance with an embodiment of the present invention while the decoder arrangement is decoding the second video sequence which is selected for output to the display device, the decoder arrangement is operative to selectively decode the first video sequence starting from an intra coded frame of the first video sequence immediately prior to the switch to selecting the first video sequence for outputting to the display device.

Moreover in accordance with an embodiment of the present invention the second video sequence includes a plurality of content items, and the decoding arrangement is operative, for each one of the content items of the second video sequence fully decoded for outputting to the display device, to only selectively decode a portion of the first video sequence corresponding to an end portion of the one content item of the second video sequence.

Further in accordance with an embodiment of the present invention before the selector selects the second video sequence for outputting to the display device, the decoder arrangement is operative to cue up the second video sequence in the decoder arrangement using selective decoding, ready for further decoding and output to the display device when needed.

Still further in accordance with an embodiment of the present invention the first video sequence includes at least one marker indicating where a part of the first video sequence is replaceable by at least part of the second video sequence.

Additionally in accordance with an embodiment of the present invention when the at least one marker is reached, the selector is operative to switch the output to the display device from the first video sequence to the second video sequence.

Moreover in accordance with an embodiment of the present invention the decoder arrangement includes one decoder operative to decode both the first video sequence and the second video sequence.

Further in accordance with an embodiment of the present invention the one decoder is operative to run at a speed greater than real-time and less than twice real-time.

Still further in accordance with an embodiment of the present invention the decoder arrangement includes a first decoder and a second decoder, the first decoder being operative to decode the first video sequence, the second decoder being operative to decode the second video sequence.

Additionally in accordance with an embodiment of the present invention, the system includes a tuner operationally connected to the decoder arrangement, the tuner being operative to receive a live stream which includes the first video sequence, the decoder arrangement being operative to perform the decoding and selective decoding of the first video sequence off of the live stream.

Moreover in accordance with an embodiment of the present invention the second video sequence is retrieved for decoding by the decoder arrangement from a storage arrangement.

Further in accordance with an embodiment of the present invention while the first video sequence is being selectively decoded, the first video sequence is not outputted to the display device.

There is also provided in accordance with still another embodiment of the present invention a method including decoding a plurality of video sequences including a first video sequence and a second video sequence, each of the video sequences including a plurality of frames including a first plurality of reference frames and a second plurality of non-reference frames, during at least some of the time while decoding the second video sequence which is selected for output to a display device, selectively decoding the first video sequence, and then switching to selecting the first video sequence for outputting to the display device for display.

### BRIEF DESCRIPTION OF THE DRAWINGS

The present invention will be understood and appreciated more fully from the following detailed description, taken in conjunction with the drawings in which:

FIG. 1 is a simplified pictorial illustration of a television system;

FIG. 2 is a simplified pictorial illustration showing commercial replacement;

FIG. 3 is a simplified pictorial illustration showing a problem with the commercial replacement of FIG. 2;

FIG. 4 is a simplified pictorial illustration showing another problem with the commercial replacement of FIG. 3;

FIG. 5 is a partly pictorial, partly block diagram view of a television system constructed and operative in accordance with an embodiment of the present invention;

FIG. 6 is a partly pictorial, partly block diagram view showing commercial replacement in the system of FIG. 5;

FIG. 7 is a more detailed view of the commercial replacement of FIG. 6;

FIG. 8 is a block diagram view of a decoder arrangement of the television system of FIG. 5; and

FIG. 9 is a block diagram view of an alternative embodiment of a decoder arrangement for use with the television system of FIG. 5.

### DETAILED DESCRIPTION OF AN EMBODIMENT

Persons skilled in the art will appreciate that, throughout the present application, switching being high-definition (HD) video sequences is used by way of example only, and that the present invention is not limited to switching between a particular type of video sequence, but rather includes, in embodiments thereof, frame accurate video switching between any suitable video sequence while using less decoder resources by employing selective decoding at least some of the time, as will be described below. Switching may be between two HD video sequences, between two standard definition (SD) video sequences, or between any between any number of arbitrary resolution video sequences.

Persons skilled in the art will appreciate that, throughout the present application, a replacement commercial/advertisement is used by way of example only, and that the present invention is not limited to a particular type of secondary video sequence, but rather includes any suitable secondary video sequence, for example, an alternative video sequence in a TV game and/or a live video stream of an adjacent TV channel.

Persons skilled in the art will appreciate that, throughout the present application, a set-top box is used by way of example only, and that the present invention is not limited to a particular type of video rendering device, but rather includes any suitable rendering device, such as a suitably configured television, computer system or mobile device, by way of example only.

Persons skilled in the art will appreciate that, throughout the present application, a television is used by way of example only, and that the present invention is not limited to a particular type of display device, but rather includes any suitable display device, such as a computer monitor, projector and screen arrangement or a mobile device having a display, by way of example only.

Persons skilled in the art will appreciate that, throughout the present application, an MPEG-2 video compression scheme is used by way of example only, and that the present invention is not limited to a particular type of compression scheme, but rather includes any suitable video compression scheme, for example, but not limited to H.264 (MPEG-4 part 10 (14496-10)) and VC-1.

Similarly, terminology commonly used with regard to the MPEG-2 standard, for example, group of pictures (GOP), I-frame, P-frame and B-frame, is not meant to be limiting, and those ordinarily skilled in the art will appreciate that terms applicable to other suitable compression standards are also included.

An I-frame is an intra coded frame, which: may be referenced for the decoding of one or more other frames; and is coded without reference to any other frame.

A P-frame is a predicted frame, which: is typically referenced for the decoding of one or more other frames; and is coded with reference to one or more other frames.

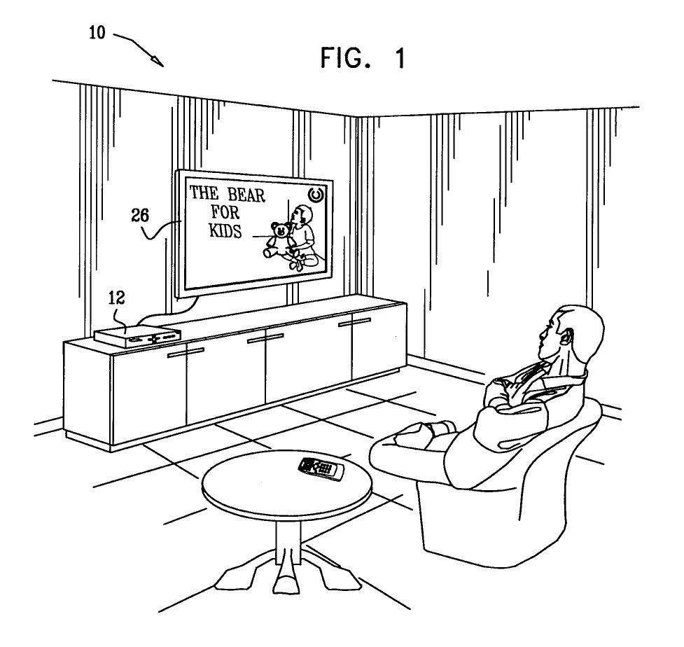

A B-frame is an example of a bi-directional predicted frame, which: is typically not referenced for the decoding of other frames; and is coded with reference to one or more other frames. Reference is now made to FIG. 1, which is a simplified pictorial illustration of a television system 10 including a television display 26 and a set-top box 12.

By way of introduction, platform operators are generally well aware of the widely diverse demographics of their subscribers. While many viewers watch the same channel, the viewers typically represent different consumer types to different advertisers. Operators may present a commercial that is relevant to one of the viewers but not the other, leading to a known problem of advertising wastage.

A known solution to the above problem is advertisement/commercial substitution, whereby commercials included in the video stream of the content may be substituted by replacement commercials stored in the set-top box 12. The replacement commercials are typically pushed to the disks of the set-top boxes 12 of the relevant subscribers by the platform operator (not shown).

The set-top box 12 of FIG. 1 is typically operative to receive live video sequences for rendering on to the television display 26 (FIG. 1).

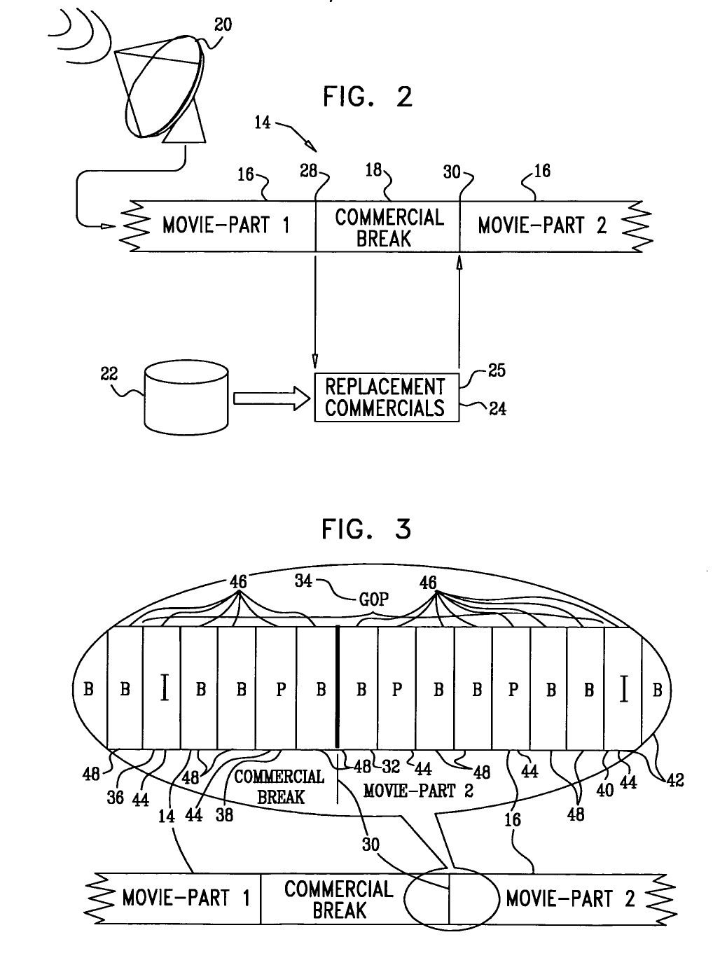

Reference is now made to FIG. 2, which is a simplified pictorial illustration showing commercial replacement.

A live video sequence 14 is shown as being received by a satellite dish 20. It will be appreciated by those ordinarily skilled in the art that the live video sequence 14 may be received by any suitable communication system, for example, but not limited to, a cable, an Internet Protocol and/or a terrestrial communication system.

The live video sequence 14 includes a first part of a movie 16 and a commercial break 18, followed by the second part of the movie 16.

The live video sequence 14 is typically received as a compressed video sequence, compressed in accordance with a compression scheme, for example, but not limited to, the MPEG-2 compression standard.

The set-top box 12 typically includes a disk 22 which has stored therein a video sequence 24 including one or more replacement commercials 25. The video sequence 24 is generally pushed to the set-top box 12 by the platform operator. It will be appreciated by those ordinarily skilled in the art that the disk 22 may be replaced by any suitable storage device, for example, but not limited to, flash storage or network accessible storage.

The stored video sequence 24 is typically received and stored as a compressed video sequence.

The set-top box 12 is typically operative to replace the rendering of the commercial break 18 with the rendering of the replacement commercials 25 of the stored video sequence 24 as follows. At a switch point 28, the set-top box 12 is typically operative to switch from decoding the live video sequence 14 to decoding the stored video sequence 24. Then, after the replacement commercials 25 have been rendered, at a switch point 30, the set-top box 12 is typically operative to switch back to decoding the live video sequence 14.

It is desirable to have frame accurate switching between the live video sequence 14 and the stored video sequence 24 at both of the switch points 28, 30, so that the transition between the movie 16 and the commercials 25 is as smooth as possible for the viewer.

Reference is now made to FIG. 3, which is a simplified pictorial illustration showing a problem with the commercial replacement of FIG. 2.

The live video sequence 14 includes a plurality of frames 46 including a first plurality of reference frames 44 (I-frames and P-frames) and a second plurality of non-reference frames 48 (B-frames).

The term “reference frame”, as used in the specification and claims, is defined as a frame which is used as a reference for the decoding of one or more other frames. The term “non-reference frame”, as used in the specification and claims, is defined as a frame which is not used as a reference for the decoding of any other frames.

The problem with returning back to decoding the live video sequence 14, after decoding the stored video sequence 24 (FIG. 2), is that the nature of most compressed streams does not allow decoding many of the frames without previously decoding an arbitrary number of reference frames. Therefore, returning to decoding the live video sequence 14 may require a pause while the decoder (not shown) reaches a point in the live video sequence 14 from which video can be displayed.

An example is shown in FIG. 3, whereby at the switch point 30, the first frame after the switch point 30 is a frame 32 (B-frame) which is in the middle of a group of pictures (GOP) 34. The frame 32 cannot be decoded without first decoding an I-frame 36 and a P-frame 38 located prior to the frame 32 in the group of pictures 34. Therefore, decoding will generally need to restart from an I-frame 40 in a next GOP 42. In addition to the delay caused, a section of the movie 16 is also skipped.

In standard definition (SD) systems, it is relatively common to have a decoder that is capable of simultaneously decoding two streams, so that the live video sequence 14 can be continuously decoded even while the stored video sequence 24 is being decoded and displayed. Therefore, returning to displaying the live video sequence 14 does not cause a noticeable delay as decoding of the live video sequence 14 never ceased. However in high definition (HD) systems, and especially with compression in accordance with ISO/IEC 14496-10 (standard for coding of audio-visual objects), decoders can generally decode one stream at a time, but not two.

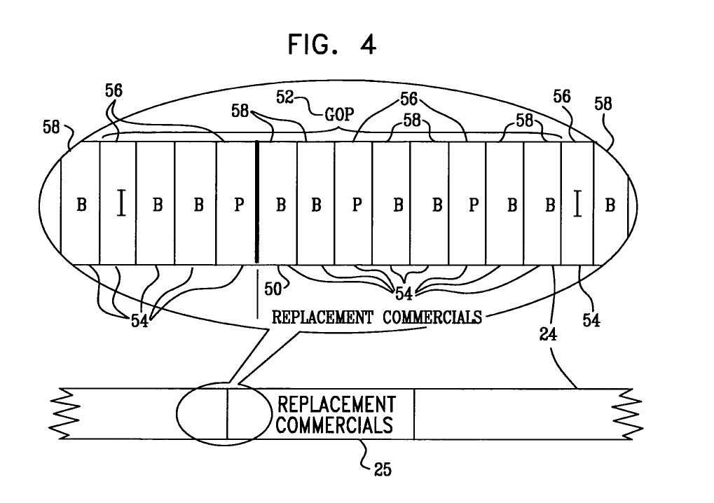

Reference is now made to FIG. 4, which is a simplified pictorial illustration showing another problem with the commercial replacement of FIG. 3.

The stored video sequence 24 typically includes a plurality of frames 54 including a first plurality of reference frames 56 (I-frames and P-frames) and a second plurality of non-reference frames 58 (B-frames).

The stored video sequence 24 typically includes other content in addition to the replacement commercials 25, for example, but not limited to, other sets of replacement commercials, so that the desired set of replacement commercials 25 may be located after the start of the stored video sequence 24 as shown in FIG. 4. Moreover, a first frame 50 in the desired set of replacement commercials 25 may be in the middle of a group of pictures 52, so that the first frame 50 cannot be decoded without first decoding prior reference frames 56 in the group of pictures 52.

Therefore, switching to decoding the stored video sequence 24 may require a pause while the decoder (not shown) reaches a point in the stored video sequence 24 from where video can be displayed.

As described above with reference to FIG. 3, in standard definition (SD) systems, it is relatively common to have a decoder that is capable of simultaneously decoding two streams. Therefore, in SD systems the stored video sequence 24 can generally be cued up even while the live video sequence 14 is being decoded and displayed so that the replacement commercials 25 are ready for decoding and display, without a noticeable delay, as soon as the replacement commercials 25 need to be displayed. However, as noted with reference to FIG. 3, in high definition (HD) systems, and especially with compression in accordance with ISO/IEC 14496-10 (standard for coding of audio-visual objects), decoders can generally decode one stream, at a time, but not two.

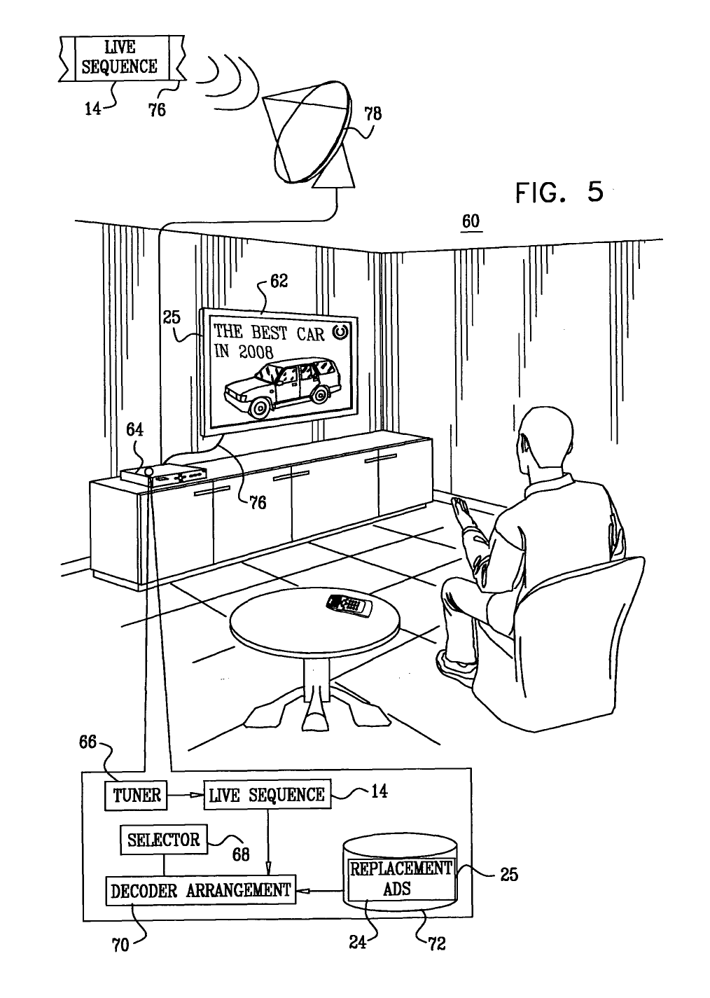

Reference is now made to FIG. 5, which is a partly pictorial, partly block diagram view of a television system 60 constructed and operative in accordance with an embodiment of the present invention.

The television system 60 typically includes a display device 62 and a set-top box 64. The display device 62 and the set-top box 64 are typically operationally connected via a communication link 76.

The set-top box 64 typically receives incoming broadcasts via a satellite receiver dish 78. However, it will be appreciated by those ordinarily skilled in the art that the set-top box 64 can be operative to receive broadcasts via any suitable communication, for example, but not limited to, cable, Internet Protocol or terrestrial communication or any suitable combination thereof.

The set-top box 64 typically includes a tuner 66, a selector 68, a decoder arrangement 70 and a disk 72. The set-top box 64 generally includes other components (not shown) found in a set-top box known to those ordinarily skilled in the art.

The tuner 66 is typically operative to receive a live stream 74 which includes the live video sequence 14.

The disk 72 is a storage arrangement typically operative to store the stored video sequence 24 therein.

The decoder arrangement 70 is typically operationally connected to the tuner 66, the selector 68 and the disk 72.

The decoder arrangement 70 is typically operative to decode a plurality of video sequences including decoding: the live video sequence 14 off of the live stream 74; and the stored video sequence 24 which is retrieved from the disk 72.

The selector 68 is typically operative to select what is decoded by the decoder arrangement 70, and how decoding is performed, as well as which of the video sequences 14, 24 is outputted to the display device 62 for display in order to be able to switch between displaying the live video sequence 14 and the stored video sequence 24.

By way of introduction, a technique for implementing trick modes is to selectively decode a video sequence, whereby only the frames displayed or reference frames for the displayed frames are decoded. Selective decoding is generally used in most decoding chips that implement trick modes. The idea of selective decoding in trick modes means that, depending on the coding strategy, typically somewhere between a half and a quarter of the frames need to be decoded to maintain a sufficient state to allow any frame to be decoded, if required. Therefore, a decoder running at between a quarter and a half real-time decoding speed is able to continuously maintain the decoding state of a video program by decoding only the reference frames.

The term “selective decoding” or “selectively decode”, in all grammatical forms thereof, as used in the specification and claims, is defined as decoding only some, but not all, of the video frames in a sequence by skipping one or more frames while in the midst of selectively decoding the sequence. For example, if there is a video sequence with frames 1-10, selective decoding would include: decoding from frame 1 to frame 10 while skipping frames 2, 4, 6, for example; or starting decoding from frame 2 and decoding until frame 8 while skipping frames 4 and/or 6, by way of example. Selective decoding may include skipping two or more adjacent frames and decoding two or more adjacent frames, by way of example only. Selective decoding is typically defined by a sliding scale of decoding one frame in a sequence or GOP up to decoding all but one frame in a sequence or GOP.

The decoding capacity of any decoder, or arrangement of decoders, is limited, for example: a decoder may not be able to fully decode two HD video sequences at the same time, as noted above with reference to FIGS. 3 and 4. Therefore, there are general advantages to be gained by using less decoding capacity during frame accurate video switching.

In the case of a decoder that cannot fully decode two HD video sequences at the same time, the same decoder may be able to fully decode one HD video sequence and still have some spare capacity. For example, the decoder may run at about 1.5 times the real-time decoding speed, also known as 1.5× performance. Therefore, the decoder has “spare capacity” of half the real-time decoding speed (over and above the capacity needed to fully decode one HD stream), herein referred to as 0.5×.

In general terms, the television system 60 is operative to support a frame accurate advertisement/commercial substitution as follows.

The live video sequence 14 provides a continuous input of video frames typically arriving at normal speed (1.0×). The decoder arrangement 70, typically having a 1.5× performance, is typically operative such that when the replacement commercials 25 of the stored video sequence 24 are being decoded and displayed by the decoder arrangement 70, the decoding performance of the decoder arrangement 70 over and above the normal decoding requirements of the stored video sequence 24, namely the remaining 0.5×, is used to maintain the state of the live video sequence 14 such that any subsequent frame in the live video sequence 14 can be decoded. Therefore, full decoding of the live video sequence 14 can be resumed at any point, for example, after the replacement commercials 25 have been rendered, without any noticeable visual artifacts. During the selective decoding, the live video sequence 14 is generally not outputted to the display device 62 for display, typically including: not copying the frames to an output buffer (not shown); not performing color-space conversion; and not resizing an image to fit a display or window.

It will be appreciated that the exact way selective decoding is employed will depending upon a variety of factors, including: the video coding format and how the video sequence 14 is encoded.

Therefore, the decoder arrangement 70 is typically operative to selectively decode the live video sequence 14 while the replacement commercials 25 are being decoded and selected for display on the display device 62. The selective decoding of the live video sequence 14 on average uses less resources of the decoder arrangement 70 than the decoding of the stored video sequence 24 which is currently being decoded.

If necessary, before the replacement commercials 25 are displayed, the stored video sequence 24 is typically cued up to the point where the replacement commercials 25 can be decoded and displayed without a noticeable delay. Generally, the cueing is similarly performed using selective decoding, using the 0.5× spare capacity of the decoder arrangement 70.

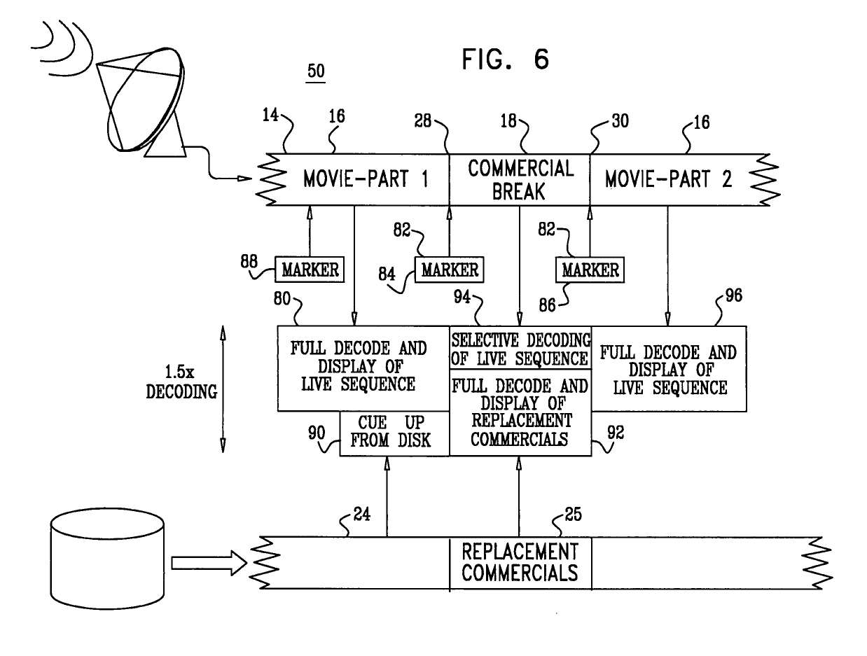

Reference is now made to FIG. 6, which is a partly pictorial, partly block diagram view showing commercial replacement in the system 60 of FIG. 5.

While the first part of the movie 16 of the live video sequence 14 is decoded and selected for output to the display device 62 (FIG. 5), the live video sequence 14 is typically fully decoded such that typically all the frames of the live video sequence 14 are decoded without skipping any of the frames (box 80).

The live video sequence 14 typically includes a plurality of markers 82, including a marker 84 at the switch point 28 and a marker 86 at the switch point 30. The markers 82 typically indicate where a part of the live video sequence 14, for example the commercial break 18, is replaceable by at least part of the stored video sequence 24, for example the replacement commercials 25.

The markers 82 are generally used by the selector 68 (FIG. 5) to: determine when to switch between outputting the live video sequence 14 and outputting the stored video sequence 24 to the display device 62 (FIG. 5) for display; and instruct the decoder arrangement 70 to fully decode or selectively decode the live video sequence 14, as appropriate.

The live video sequence 14 optionally includes another marker 88 which is used by the selector 68 (FIG. 5) to determine when to start cueing up the stored video sequence 24 in the decoder arrangement 70, if cueing up is necessary.

If cueing up is necessary, before the selector 68 (FIG. 5) typically selects the stored video sequence 24 for outputting to the display device 62 (FIG. 5) at the switch point 28, the decoder arrangement 70 (FIG. 5) is generally operative to cue up the stored video sequence 24 in the decoder arrangement 70 using selective decoding, ready for further decoding and outputting for display when needed at the switch point 28 (box 90). The term “cue up”, in all grammatical forms thereof, as used in the specification and claims, is defined herein as decoding any frames necessary such that the desired content in the stored video sequence 24 can be decoded and displayed without any noticeable delay at the switch point 28.

Then, when the switch point 28 is reached, indicated by the marker 84, the selector 68 (FIG. 5) is typically operative to switch the outputting to the display device 62 (FIG. 5) from the live video sequence 14 to the stored video sequence 24. Therefore, while the decoder arrangement 70 (FIG. 5) is decoding the live video sequence 14 which is selected for output to the display device 62 (FIG. 5), the selector 68 (FIG. 5) is generally operative to select the stored video sequence 24 for decoding by the decoder arrangement 70 and output to the display device 62 (FIG. 5).

While the stored video sequence 24 is being decoded and selected for output to the display device 62 (FIG. 5), the stored video sequence 24 is fully decoded, generally decoding all frames of the stored video sequence 24 (box 92).

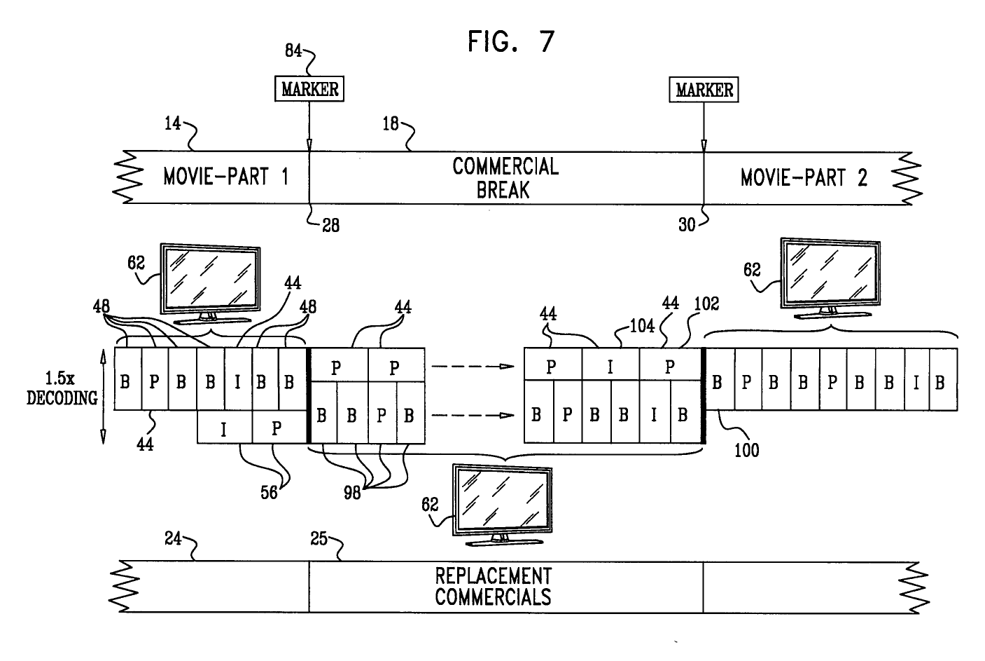

While the decoder arrangement 70 (FIG. 5) is decoding the stored video sequence 24 which is selected for output to the display device 62 (FIG. 5), the decoder arrangement 70 (FIG. 5) is typically operative to selectively decode the live video sequence 14 (box 94). The selective decoding of the live video sequence 14 generally on average uses less resources of the decoder arrangement 70 (FIG. 5) than the decoding of the stored video sequence 24 which is currently being decoded. The selective decoding is described in more detail with reference to FIG. 7.

Then, at the switch point 30 (indicated by the marker 86) or the end of the replacement commercials 25, the selector 68 (FIG. 5) is typically operative to: switch back to selecting the live video sequence 14 again for full decoding and outputting to the display device 62 (FIG. 5) (box 96); and stop decoding of the stored video sequence 24.

It should be noted that when one of the video sequences 14, 24 is outputted to the display device 62 (FIG. 5), the displayed video is decoded such that the displayed video is displayed at normal playback speed.

It will be appreciated that as both the live video sequence 14 and the stored video sequence 24 have maintained states in the decoder at the switch points 28, 30, the switch between the live video sequence 14 and the stored video sequence 24 is performed in the uncompressed domain.

It will be appreciated by those ordinarily skilled in the art that issues relating to pipelining of the decoding process, or the out of order nature of decoding, have been omitted for the sake of clarity, as the issues generally do not impact the television system 60.

Reference is now made to FIG. 7, which is a more detailed view of the commercial replacement of FIG. 6.

The decoding of the live video sequence 14 and the stored video sequence 24 is now described in more detail.

Prior to the switch point 28, denoted in the live video sequence 14 by the marker 84, the live video sequence 14 is: typically fully decoded, including decoding the non-reference frames 48 (B-frames) and the reference frames 44 (I-frames and P-frames); and selected for output to the display device 62.

Additionally, if necessary, prior to the switch point 28, the stored video sequence 24 is cued-up by decoding the reference frames 56 (an I-frame and a P-frame in the example of FIG. 7) necessary for decoding the replacement commercials 25, so that after the switch point 28 has been reached, a plurality of frames 98 in the stored video sequence 24 can be decoded without a viewer seeing a noticeable delay on the display device 62. The stored video sequence 24 is cued-up by selective decoding using the spare 0.5× performance of the decoder arrangement 70 (FIG. 5).

Therefore, the reference frames 44 and the non-reference frames 48 are decoded using the 1.0× decoding performance, and the reference frames 56 are decoded using the remaining 0.5× decoding performance. FIG. 7 shows that each of the reference frames 44 and the non-reference frames 48 of the live video sequence 14 take one frame period to decode, whereas each of the reference frames 56 take two frame periods to decode. The decoding is shown as being time-sliced, whereby the live video sequence 14 and the stored video sequence 24 are decoded at the same time. However, it should be noted that there are many ways to distribute the 1.5× decoding performance between the live video sequence 14 and the stored video sequence 24, for example, using a non-time-sliced method based on a repeating sequence of decoding two frames 44, 48 of the live video sequence 14 one after the other, each taking two-thirds of a frame period to decode; and then decoding one reference frame 56, which is also decoded in two-thirds of a frame period.

During the selective decoding of the live video sequence 14 at least some, typically a majority, of the reference frames 44 of the live video sequence 14 are decoded, and at least some, typically a majority, of the non-reference frames 48 in the midst of the live video sequence 14 being decoded are not decoded.

In accordance with an embodiment of the present invention, during the selective decoding, all the reference frames 44 are decoded and none of the non-reference frames 48 are decoded. In other words, the non-reference frames 48 are dropped.

As described above, during the period of selective decoding of the live video sequence 14, the decoder arrangement 70 (FIG. 5) generally maintains the state of the live video sequence 14 such that the decoder arrangement 70 can restart decoding and output for display of the live video sequence 14 at any time. For example, in FIG. 7, the next frame after the switch point 30 is a B-frame 100 which requires a P-frame 102 and an I-frame 104 to be decoded. If the state of the live video sequence 14 was not maintained, the B-frame 100 cannot generally be decoded. It should be noted that the state of the live video sequence 14 is continuously updated during the selective decoding. The stored video sequence 24 is using most of the decoding power (approximately 1.0× decoding performance) between the switch point 28 and the switch point 30. FIG. 7 shows that each of the reference frames 44 are decoded over two frame periods using the remaining 0.5× decoding performance. However, it should be noted that a non-time-sliced decoding method could be used, as described above.

In accordance with an alternative embodiment of the present invention, for only part of the time while the decoder arrangement 70 (FIG. 5) is decoding the stored video sequence 24 which is selected for output to the display device 62, the decoder arrangement 70 is operative to selectively decode the live video sequence 14. The selective decoding typically starts from an intra coded frame (for example, the I-frame 104) of the live video sequence 14 immediately prior to the switch point 30. The start of the selective decoding of the live video sequence 14 may be before the intra coded frame immediately prior to the switch point 30 to allow for timing errors.

The start of the selective decoding could be driven from the playback of the stored video sequence 24, as follows. If a GOP has a length of 0.5 seconds or less, by way of example only, then selective decoding needs to start at least 0.5 seconds before the end of the stored video sequence 24. Alternatively, the start of the selective decoding may be signaled by a marker in the stored video sequence 24 or in the live video sequence 14 or via another information source such as a schedule stream, a network connection or an advertisement substitution engine using system time, by way of example only.

So far, the television system 60 (FIG. 5) has been described as replacing the whole commercial break 18 of the live video sequence 14 with the whole set of replacement commercials 25 of the stored video sequence 24. However, it will be appreciated that only one or more, but not all, of the commercials in the commercial break 18 may be replaced by a commercial or commercials from the replacement commercials 25 (and optionally a commercial or commercial from one or more other sequences), so that one or more of the commercials in the commercial break 18 is fully decoded and displayed. For example, the viewer may be presented with a choice of commercials, one or more taken from the commercial break 18 of the live video sequence 14, one or more taken from the stored video sequence 24 and optionally one or more taken from one or more other video sequences (not shown). By way of another example, a decision engine (not shown), based on viewer preferences, may decide to fully decode and display: one or more commercials from the live video sequence 14; and one or more of the commercials of the replacement commercials 25. The decision engine may be located in the set-top box 64 (FIG. 5) or alternatively located at Headend which sends instructions to the set-top box 64 via a suitable communication channel.

As switching between the live video sequence 14 and the stored video sequence 24 may occur in the middle of the commercial break 18 and the replacement commercials 25, for example between individual commercials, the selective decoding of the live video sequence 14 cannot be restricted to starting with the last GOP before the end of the commercial break 18. Instead, the selective decoding needs to be performed for at least the last GOP of each individual commercial in the commercial break 18.

By way of a non-limiting example, the commercial break 18 and the replacement commercials 25 each include four commercials of the same duration. While the first commercial of the replacement commercials 25 is being fully decoded and displayed, the live video sequence 14 is not decoded at all until the last GOP of the first commercial when selective decoding is performed. Once the first commercial has finished playing, the second commercial of the replacement commercials 25 is fully decoded and displayed. When the second commercial of the replacement commercials 25 starts playing, the selective decoding of the live video sequence 14 is interrupted until the last GOP of the second commercial. From the beginning of the second commercial until before the last GOP of the second commercial, the live video sequence 14 is not decoded at all. The television system 60 (FIG. 5) then decides to fully decode and display the third commercial of the commercial break 18 of the live video sequence 14. Meanwhile, the stored video sequence 24 is cued-up until the beginning of the fourth commercial, so that the fourth commercial is ready for decoding and display if needed. The television system 60 then decides to fully decode and display the fourth commercial of the replacement commercials 25. From the start of the fourth commercial, the live video sequence 14 is not decoded at all until the last GOP of the commercial break 18, when selective decoding is restarted, so that the live video sequence 14 can be fully decoded and displayed at the end of the commercial break 18.

Therefore, in general terms, the stored video sequence 24 (for example, but not limited to, the replacement commercials 25) includes a plurality of content items (for example, but not limited to, a plurality of commercials). The decoder arrangement 70 (FIG. 5) is operative, for each content item of the stored video sequence 24 fully decoded for outputting to the display device 62, to only selectively decode a portion of the live video sequence 14 corresponding to an end portion (for example, the last GOP) of the content item of the stored video sequence 24. The portion of the live video sequence 14 prior to the end portion is typically not decoded at all.

In accordance with an embodiment of the present invention, the selective decoding of the live video sequence 14 is performed during a majority of the time while the decoder arrangement 70 (FIG. 5) is decoding the stored video sequence 24 which is selected for output to the display device 62.

The selective decoding generally requires that the decoder arrangement 70 (FIG. 5) has a buffer (not shown) which is large enough to hold the compressed image data prior to deciding if a frame can be dropped or if the frame needs to be decoded. It will be appreciated by those ordinarily skilled in the art that the size of the buffer can be calculated based on the speed of the decoder arrangement 70.

Apart from the general requirement that the decoder arrangement 70 operates faster than real-time, typically 1.5× performance, the decoder arrangement 70 typically needs sufficient memory to store two sets of decoding states including all reference images.

In accordance with an alternative embodiment of the present invention, during the selective decoding of the live video sequence 14, at least a majority, or all, of the frames of the live video sequence 14 being decoded are I-frames. The alternative embodiment may be useful for example where the set-top box 64 (FIG. 5) only has enough decoding performance and/or enough memory to decode the I-frames of the live video sequence 14 during the selective decoding. During selective decoding, the I-frames are typically decoded to base-band video and the decoded I-frames are not output to the display device 62 for display. At the end of the replacement commercials 25, decoding is generally switched back to the live video sequence 14. As soon as the switch is made, the decoder arrangement 70 (FIG. 5), which was only decoding I-frames in the live video sequence 14, changes to decoding all the frames of the live video sequence 14 as soon as possible. In order to prevent a display interruption at the end of the replacement commercials 25, one or more of the previously decoded I-frames in the live video sequence 14 are typically displayed on the display device 62.

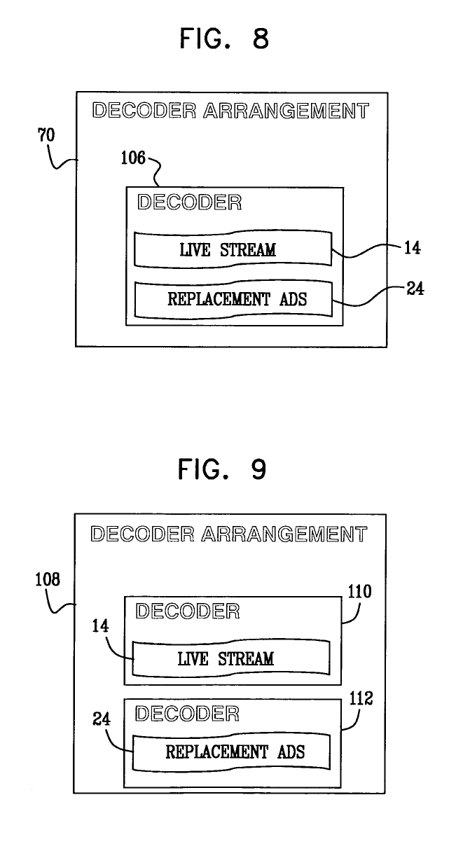

Reference is now made to FIG. 8, which is a block diagram view of the decoder arrangement 70 of the television system 60 of FIG. 5.

The decoder arrangement 70 typically includes a single decoder 106 operative to decode both the live video sequence 14 and the stored video sequence 24. The decoder 106 is typically operative to run at a speed greater than real-time, but less than twice real-time.

There are situations where both the live video sequence 14 and the stored video sequence 24 could practically be fully decoded in the decoder 106 at the same time, but it is more advantageous to selectively decode the live video sequence 14 while the stored video sequence 24 is being fully decoded. For example, when the live video sequence 14 is HD and the stored video sequence 24 is SD, or vice-versa, even though the decoder 106 has the resources to fully decode the HD stream together with the SD stream at the same time, it could still be advantageous to selectively decode the live video sequence 14 while the stored video sequence 24 is being fully decoded to allow the decoder 106 to perform another task, for example, but not limited to, fully decoding one or more SD streams, or selectively decoding another HD stream (possibly to allow to switching to any one of a plurality of streams).

Underutilizing the decoder 106 also generally allows bus bandwidth use to be reduced for the particular application, enabling other items like graphics to be added to the outgoing composition.

It will be appreciated by those ordinarily skilled in the art that the decoder 106 may also be able to fully decode two HD streams at the same time. Although, it is understood that such a decoder is not currently commercially available, it is only a matter of time before decoders will have such performance. In such a case, the selective decoding of the live video sequence 14 will enable the decoder 106 to utilize any spare decoding capacity for other uses such as: fully or selectively decoding an SD or HD stream; or generating overlay graphics at frame-rate which use significant memory and bandwidth, by way of example only. Hence, the television system 60 has a general benefit beyond the point where a decoder can decode at twice real-time speed.

Reference is now made to FIG. 9, which is a block diagram view of an alternative embodiment of a decoder arrangement 108 for use with the television system 60 of FIG. 5.

The decoder arrangement 108 typically includes a decoder 110 and a decoder 112. The decoder 110 is typically operative to decode the live video sequence 14. The decoder 112 is generally operative to decode the stored video sequence 24.

Although with the decoder arrangement 108, the live video sequence 14 does not need to be selectively decoded during the period between the switch point 28 and the switch point 30 (FIGS. 6 and 7), as the decoder 110 has enough capacity to be able to fully decode the live video sequence 14, selectively decoding the live video sequence 14 gives the decoder 110 spare capacity to perform other decoding operations.

The television system 60 has been described above with reference to replacing a commercial break 18 in the live video sequence 14 with the replacement commercials 25 of the stored video sequence 24. However, it will be appreciated by those ordinarily skilled in the art that the television system 60 may be used to switch between any content type, whether both the streams are live, both the streams are stored locally, or one of the streams is live and the other is stored locally. It will also be appreciated by those ordinarily skilled in the art that switching may take place between two or more streams.

Examples of other uses of the television system 60 are now described below. The embodiments described in the examples may be particularly suited to using two decoders together or a future decoder having 2.0× performance or more.

A first example is a live interactive TV game (for example Xtreamplay™ by NDS Limited of One Heathrow Boulevard, 286 Bath Road, West Drayton, Middlesex UB7 0DQ, United Kingdom) which may include any number of live video streams for the game to switch between at any point in the game. Only one of the video streams needs to be fully decoded at any point in time. The other streams can be selectively decoded.

A second example is an interactive advertisement/commercial replacement system, whereby an HD stream including a replacement commercial is fully decoded and an alternative HD stream is selectively decoded to be available for jumping to at any point during the replacement commercial. Additionally, the state of an original broadcast is maintained in order to be able to return to the original broadcast at the end of the replacement commercial.

A third example is fast channel change system whereby the current channel is fully decoded and displayed while one or more adjacent channels are selectively decoded so that one of the adjacent channels can be displayed quickly upon selection by the viewer.

Audio does not generally suffer from the long latency of video and therefore a secondary audio stream can be fully decoded to allow for base-band audio switching. In addition, typical techniques include constructing content with silence at the start and end such that audio synchronization is not a problem for the television system 60.

Other streams, such as subtitles or closed captions depend very much on the mechanism, but are also typically very low CPU overhead streams, and therefore can be handled by the simple expedient of fast decoding. Closed captions may be included in user data inside the video, and as such would not be problematic. Subtitles, such as provided by an additional stream, if present, can typically be decoded faster than real-time.

It is appreciated that software components of the present invention may, if desired, be implemented in ROM (read only memory) form. The software components may, generally, be implemented in hardware, if desired, using conventional techniques.

It will be appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination. It will also be appreciated by persons skilled in the art that the present invention is not limited by what has been particularly shown and described hereinabove. Rather the scope of the invention is defined only by the claims which follow.

1-23. (canceled)

24. A system comprising:
a decoder arrangement to decode a plurality of video sequences including a first video sequence and a second video sequence, each of the video sequences including a plurality of frames including a first plurality of reference frames and a second plurality of non-reference frames, the second video sequence including at least one content item;
a selector operationally connected to the decoder arrangement, the selector being operative to select which of the video sequences is outputted to a display device for display, the selector being operative to select:
the first video sequence for decoding by the decoder arrangement and outputting to the display device for display; then
the second video sequence for decoding by the decoder arrangement and outputting to the display device for display; and then
the first video sequence for outputting to the display device for display,
wherein while the decoder arrangement is decoding the second video sequence which is selected for output to the display device, the decoder arrangement is operative to start selectively decoding the first video sequence at a time corresponding to the decoding of an end portion of the at least one content item of the second video sequence, the selective decoding being performed by decoding at least one, but not all, of the frames in the first video sequence, by skipping at least one of the frames of the first video sequence while in the midst of selectively decoding the first video sequence.

25. A system comprising:
a decoder arrangement to decode a plurality of video sequences including a first video sequence and a second video sequence, each of the video sequences including a plurality of frames including a first plurality of reference frames and a second plurality of non-reference frames;
a selector operationally connected to the decoder arrangement, the selector being operative to select which of the video sequences is outputted to a display device for display, the selector being operative to select:
the first video sequence for decoding by the decoder arrangement and outputting to the display device for display; then
the second video sequence for decoding by the decoder arrangement and outputting to the display device for display; and then
the first video sequence for outputting to the display device for display,
wherein the decoder arrangement is operative to selectively decode the first video sequence during at least some of the time while the decoder arrangement is decoding the second video sequence which is selected for output to the display device, the selective decoding being performed by decoding at least one, but not all, of the frames in the first video sequence, by skipping at least one of the frames of the first video sequence while in the midst of selectively decoding the first video sequence.

26. The system according to claim 25, wherein the selective decoding maintains a state of the first video sequence such that any subsequent frame in the first video sequence can be decoded whereby full decoding of the first video sequence can be resumed at any point without any noticeable visual artifacts.

27. The system according to claim 25, wherein while the decoder arrangement is decoding the second video sequence which is selected for output to the display device, the selective decoding of the first video sequence on average uses less resources of the decoder arrangement than the decoding of the second video sequence which is currently being decoded.

28. The system according to claim 25, wherein during the selective decoding of the first video sequence, at least some of the non-reference frames in the midst of the first video sequence being selectively decoded are not decoded.

29. The system according to claim 25, wherein during the selective decoding of the first video sequence at least a majority of the frames of the first video sequence being decoded are reference frames.

30. The system according to claim 25, wherein:
the reference frames include a plurality of intra coded frames; and
during the selective decoding of the first video sequence, at least a majority of the frames of the first video sequence being decoded are intra coded frames.

31. The system according to claim 25, wherein while the first video sequence is being decoded and selected for output to the display device, the first video sequence is fully decoded.

32. The system according to claim 25, wherein while the second video sequence is being decoded and selected for output to the display device, the second video sequence is fully decoded.

33. The system according to claim 25, wherein during a majority of the time while the decoder arrangement is decoding the second video sequence which is selected for output to the display device, the decoder arrangement is operative to selectively decode the first video sequence.

34. The system according to claim 25, wherein while the decoder arrangement is decoding the second video sequence which is selected for output to the display device, the decoder arrangement is operative to selectively decode the first video sequence starting from an intra coded frame of the first video sequence immediately prior to the switch to selecting the first video sequence for outputting to the display device.

35. The system according to claim 25, wherein:
the second video sequence includes a plurality of content items; and
the decoding arrangement is operative, for each one of the content items of the second video sequence fully decoded for outputting to the display device, to only selectively decode a portion of the first video sequence corresponding to an end portion of the one content item of the second video sequence.

36. The system according to claim 25, wherein before the selector selects the second video sequence for outputting to the display device, the decoder arrangement is operative to cue up the second video sequence in the decoder arrangement using selective decoding, ready for further decoding and output to the display device when needed.

37. The system according to claim 25, wherein the first video sequence includes at least one marker indicating where a part of the first video sequence is replaceable by at least part of the second video sequence.

38. The system according to claim 37, wherein when the at least one marker is reached, the selector is operative to switch the output to the display device from the first video sequence to the second video sequence.

39. The system according to claim 25, wherein the decoder arrangement includes one decoder operative to decode both the first video sequence and the second video sequence.

40. The system according to claim 39, wherein the one decoder is operative to run at a speed greater than real-time and less than twice real-time.

41. The system according to claim 25, wherein the decoder arrangement includes a first decoder and a second decoder, the first decoder being operative to decode the first video sequence, the second decoder being operative to decode the second video sequence.

42. The system according to claim 25, further comprising a tuner operationally connected to the decoder arrangement, the tuner being operative to receive a live stream which includes the first video sequence, the decoder arrangement being operative to perform the decoding and selective decoding of the first video sequence off of the live stream.

43. The system according to claim 25, wherein the second video sequence is retrieved for decoding by the decoder arrangement from a storage arrangement.

44. The system according to claim 25, wherein while the first video sequence is being selectively decoded, the first video sequence is not outputted to the display device.

45. A method comprising:
decoding a plurality of video sequences including a first video sequence and a second video sequence, each of the video sequences including a plurality of frames including a first plurality of reference frames and a second plurality of non-reference frames;
selecting the first video sequence for decoding by the decoder arrangement and outputting to a display device for display; then
selecting the second video sequence for decoding by the decoder arrangement and outputting to the display device for display;
selectively decoding the first video sequence during at least some of the time while the second video sequence is being decoded and selected for output to the display device, the selective decoding being performed by decoding at least one, but not all, of the frames in the first video sequence, by skipping at least one of the frames of the first video sequence while in the midst of selectively decoding the first video sequence; and then
selecting the first video sequence for outputting to the display device for display.

46. A system comprising:
means for decoding a plurality of video sequences including a first video sequence and a second video sequence, each of the video sequences including a plurality of frames including a first plurality of reference frames and a second plurality of non-reference frames;
means for selecting which of the video sequences is outputted to a display means for display, the selecting means being operative to select:
the first video sequence for decoding by the decoding means and outputting to the display means for display; then
the second video sequence for decoding by the decoding means and outputting to the display means for display; and then
the first video sequence for outputting to the display means for display,
wherein the decoding means is operative to selectively decode the first video sequence during at least some of the time while the decoding means is decoding the second video sequence which is selected for output to the display means, the selective decoding being performed by decoding at least one, but not all, of the frames in the first video sequence, by skipping at least one of the frames of the first video sequence while in the midst of selectively decoding the first video sequence.
